(19) United States
(12) Patent Application Publication
(10) Pub. No.: US 2015/0344817 A1
(43) Pub. Date: Dec. 3, 2015

(54) WATER CLUSTER-DOMINANT BORONIC ACID ALKALI SURFACTANT COMPOSITIONS AND THEIR USE

(71) Applicant: The Procter & Gamble Company, Cincinnati, OH (US)

(72) Inventor: Freddy Arthur BARNABAS, West Chester, OH (US)

(21) Appl. No.: 14/724,527

(22) Filed: May 28, 2015

Related U.S. Application Data
(60) Provisional application No. 62/005,311, filed on May 30, 2014.
(60) Provisional application No. 62/109,924, filed on Jan. 30, 2015.

(51) Int. Cl. C11D 1/02; C11D 3/04; A23L 1/00; C11D 1/04

(52) U.S. Cl. CPC C11D 1/02; C11D 1/04; C11D 3/044; A23L 1/0011; A23V 2002/00

(57) ABSTRACT

An aqueous alkali-surfactant solution having a hydroxide molarity of from 2 to 9 M that comprises alkali and a surfactant having a boron-centered head group positioned terminally in a linear or branched aliphatic or aryl hydrocarbon chain comprising from 4 to 10 carbon atoms. The boron-centered head group can be selected from boronic acids and their derivatives. Boronic acid alkali-surfactant treatment processes, such as cleaning, chemical pulping, mercerization, metal processing, leather processing, food processing, and personal beauty care. The process comprises the step of contacting a substrate with an effective amount of an aqueous boronic acid alkali-surfactant composition.

### FIELD OF THE INVENTION

The present invention relates to water cluster-dominant boronic acid alkali surfactant compositions and to their methods of use.

### BACKGROUND OF THE INVENTION

High concentration caustic solutions, such as alkali hydroxides in water, are widely used in a variety of industrial, commercial, office, and home applications. Wood pulp digestion, industrial cleaning, paint removing, aluminum etching, and mercerization are examples of typical processes utilizing large volumes of caustic solution. However, alkali solution has a very high surface tension making its performance less than optimal for many applications. Because of its high surface tension, it slowly penetrates into substrates that it wets, may not penetrate at all, and can even roll off many surfaces. It also does not mix well with non-aqueous fluids like oils and fats, where mixing is imperative to effecting the desired chemical transformations.

Conversely, hydrocarbon solvents easily wet and penetrate many surfaces and have good solvating power (i.e., ability to dissolve) toward many materials. For example, many fluorinated or chlorinated hydrocarbons have been extensively used for cleaning, degreasing, and preparing parts for plating or coating operations. Such solvents are effective in removing many of the toughest industrial soils, yet for many purposes they are inadequate since they lack alkali's hydrolyzing power. Furthermore, many of these solvents are flammable and regulated as volatile organic compounds, with some of the solvents invariably lost into the atmosphere during the drying process.

Because of lower environmental impact, aqueous systems would be preferred over those involving hydrocarbon solvents. However, for a cleaner including degreasers such an aqueous system would need to be able to effectively remove tough industrial soils, such as rust inhibitors, greases, oils, buffing compounds, waxes, cutting oils, forming oils and quench oils.

Thus, it would be desirable to provide an aqueous composition having both the wetting and penetrating characteristics of solvents as well as the hydrolyzing power of alkali.

### SUMMARY OF THE INVENTION

The present invention provides alkali surfactant compositions having high alkali concentration, excellent material penetration ability, and superior wetting ability. These aqueous compositions comprise a surfactant agent having a Lewis acid head functionality and a short chain hydrophobic (e.g. hydrocarbon) tail. The chemical bond between the primary atom of the head group and the closest backbone atom of the tail is non-hydrolysable in concentrated alkali solution. In one embodiment, the surfactant agent comprises a boronic acid head group and a hydrocarbon tail group having from 4 to 10 carbon atoms.

The surfactant agent can be present in the composition at a level of from 0.05% to 30%, or from 0.1% to 10%, or from 0.1 to 5%, by weight of the total composition. The alkali composition can desirably have a hydroxide Molarity of from 2 to 9 M, or from 4 to 9 M.

### BRIEF DESCRIPTION OF THE DRAWINGS

FIG. 1 is a plot of KOH Molarity (“M”) versus dynamic surface tension at 51 milliseconds (‘ms”) for aqueous KOH solutions of varying concentration.

FIG. 2 is a plot of KOH concentration versus dynamic surface tension at 51 ms for solutions of butyl boronic acid and solutions of Amphoteric-16 surfactant.

### DETAILED DESCRIPTION OF THE INVENTION

### I. Definitions

As used herein, articles such as “a” and “an” and “the” are understood to mean one, or a combination of more than one, of what is claimed or described. For example, “a material” means one material or a collective mixture of more than one material. It should be apparent that as used herein, terms such as “a material”, “the material” and “material” are synonymous and thus used interchangeably.

As used herein, the term “an alkali” or “alkali” means one or a combination of more than one alkali material.

As used herein, the term “a surfactant” or “surfactant” means one or a combination of more than one surfactant. For example, “10% surfactant” means that the collective total of surfactant present is 10%, whether in the form of one surfactant or the form of a mixture of more than one surfactant (e.g., two surfactants of differing tail lengths).

As used herein, “an alkali metal salt” means one or a mixture of more than one alkali metal salt.

As used herein, “a non-metal base” means one or a mixture of more than one non-metal base.

As used herein, the terms “include”, “contain”, and “have” are non-limiting and do not exclude other components or features beyond those expressly identified in the description or claims.

As used herein, “adjunct” means an optional material that can be added to a composition to complement the aesthetic and/or functional properties of the composition.

As used herein, “carrier” means an optional material, including but not limited to a fluid, that can be combined with the composition to facilitate delivery and/or use.

As used herein, the term “solid” includes granular, powder, bar and tablet product forms.

As used herein, the term “fluid” includes liquid, gel, and paste product forms.

All percentages and ratios are calculated based on weight of the total composition unless otherwise indicated.

Unless otherwise noted, all component (i.e., ingredient) or composition levels are in reference to the active portion of that component or composition, and are exclusive of impurities, for example, residual solvents or by-products, which may be present in commercially available sources of such components or compositions.

All percentages are by weight percent of the total composition unless otherwise indicated.

As used herein, the term “hydrocarbon radical” means a polymeric radical comprising only carbon and hydrogen. For example, a hydrocarbon radical can include an alkyl radical and/or a phenyl radical.

As used herein, the term “radical” is used synonymously with the terms “group” and/or “moiety”.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, the “primary atom of the head group” is the head group atom that is directly bonded to the hydrocarbon tail.

### II. Alkali Surfactant Composition

The aqueous alkali surfactant composition of the present invention comprises: (a) an alkali salt; and (b) a surfactant. The molarity of the composition can range from 2 to 9 M, or from 4 to 9 M. The surfactant can be present in an amount from 0.05% to 30%, or from 0.1% to 10%, or from 0.1 to 5%, by weight of the total composition. The surfactant has a Lewis acid head group (hydrophilic moiety) attached to a hydrocarbon tail (hydrophobic moiety) having from 4 to 10 carbon atoms.

As used herein, a “Lewis acid” head group is (1) a fully classical Lewis acid and/or (2) contains a Lewis site due to electron deficiency. In the Lewis theory of acid-base reactions, bases donate pairs of electrons and acids accept pairs of electrons. A Lewis acid is therefore any entity, such as the H+ ion, that can accept a pair of nonbonding electrons. In other words, a fully classical Lewis acid is an electron-pair acceptor. Some molecules have electron-deficient bonds referred to as Lewis sites. Lewis sites occur when a molecule has too few valence electrons to form a stable octet structure. Examples of compounds that are electron deficient are the boranes, which are often described as having 3-center-2-electron bonds. Such species readily react with Lewis bases (i.e., lone-pair sources) to give stable adducts.

The hydrocarbon tail comprises from 4 to 10 carbon atoms, and can be an alkyl group that is straight or branched, or in some cases can comprise an aryl group. In other embodiments, the tail comprises from 4 to 8 carbon atoms, or from 4 to 6 carbon atoms.

Various components of the alkali surfactant composition of the present invention are discussed in more detail below.

A. Alkali

The aqueous alkali composition of the present invention has a molarity of from 2 to 9 M, or from 4 to 9 M, and comprises a strong base. A strong base is a chemical compound that is able to deprotonate very weak acids in an acid-base reaction. Common examples of strong bases include alkali salts, which are soluble hydroxides of alkali metals and alkaline earth metals. Examples of such bases include Potassium hydroxide (KOH), Barium hydroxide (Ba(OH)₂), Cesium hydroxide (CsOH), Sodium hydroxide (NaOH), Strontium hydroxide (Sr(OH)₂), Calcium hydroxide (Ca(OH)₂), Lithium hydroxide (LiOH), Rubidium hydroxide (RbOH), and combinations thereof. The cations of these strong bases appear in the first and second groups of the periodic table (alkali and earth alkali metals).

In one embodiment, the base is NaOH and the composition has a molarity of about 4 M. In another the base is KOH and the composition has a molarity of from about 4 M to about 5 M. In others, the base is LiOH and the composition has a molarity of from about 2 M to about 9 M.

Strong non-metal bases, such as ammonium hydroxide, can also be useful. In one embodiment, the composition comprises a non-metal base, such as ammonium hydroxide or alkyl substituted ammonium hydroxide. In particular embodiments, the composition comprises an alkyl substituted ammonium hydroxide selected from the group consisting of tetramethyl ammonium hydroxide, trimethyl ammonium hydroxide, tributylammonium hydroxide, tetrabutyl ammonium hydroxide, and combinations thereof.

In an alternate embodiment, the composition is in the form of a gel. As appropriate, the gel can be used in the gel form (e.g., in use situations where it is desirable for the composition to “cling”) or can be used as a concentrate that is diluted before use.

As discussed in more detail herein, the composition's alkali molarity is closely associated with water cluster concentration.

B. Surfactant

The surfactant herein has a boron-centered head group positioned terminally in a linear or branched aliphatic or aryl hydrocarbon chain comprising from 4 to 10 carbon atoms. The boron-centered head group can be a boronic acid or boronic acid derivative such as a boroxine, a boronic ester, or a borane.

Any suitable boronic acid (or boronic acid derivative) surfactant can be used herein. For example, the boronic acid surfactant can be selected from the group consisting of butyl boronic acid; pentyl boronic acid; hexyl boronic acid; isobutyl boronic acid; phenyl boronic acid; 3,5-Dichlorophenyl boronic acid; 3,5-bis(Trifluoromethyl)phenyl boronic acid; 3-Methoxyphenyl boronic acid; 4-Methoxyphenyl boronic acid; 4-Carboxyphenyl boronic acid; 2-Nitrophenyl boronic acid; 4-Nitrophenyl boronic acid; 4-Bromophenyl boronic acid; 4-Flourophenyl boronic acid; 2-Methylphenyl boronic acid; 3-Methylphenyl boronic acid; 4-Methylphenyl boronic acid; 3,5-Dimethylphenyl boronic acid; derivatives thereof, and combinations thereof.

The surfactant can be present in the composition at a level of from 0.05% to 30%, or from 0.1% to 10%, or from 0.1 to 5%, by weight of the total composition. The surfactant has a Lewis acid head group (hydrophilic moiety) attached to a hydrocarbon tail (hydrophobic moiety) having from 4 to 10 carbon atoms. As used herein, a “Lewis acid” head group is a (1) fully classical Lewis acid and/or (2) contains a Lewis site due to electron deficiency.

The hydrocarbon tail comprises from 4 to 10 carbon atoms, and can be an alkyl group that is straight or branched, or in some cases can comprise an aryl group. In other embodiments, the tail comprises from 4 to 8 carbon atoms, or from 4 to 6 carbon atoms.

The chemical bond between the primary atom of the head group and the closest backbone atom of the tail is non-hydrolysable in concentrated alkali solution. This bond, which is a dipolar bond (also known as a dative covalent bond, or coordinate bond), is a kind of 2-center, 2-electron covalent bond in which the two electrons derive from the same atom. A dipolar bond is formed when a Lewis base (in this case, from the tail group) donates a pair of electrons to a Lewis acid (the head group). In contrast, each atom of a standard covalent bond contributes one electron.

1. Boronic Acid and Derivatives Thereof

The surfactant herein has a boron-centered head group positioned terminally in a linear or branched aliphatic or aryl hydrocarbon chain comprising from 4 to 10 carbon atoms. The boron-centered head group can be a boronic acid or boronic acid derivative such as a boroxine, a boronic ester, or a borane.

A boronic acid is an alkyl or aryl substituted boric acid containing a carbon-boron bond. Boronic acids act as Lewis acids. They are electron-pair acceptors and therefore able to react with a Lewis base to form a Lewis adduct by sharing the electron pair furnished by the Lewis base. In one embodiment, the surfactant is a boronic acid represented by formula (I) below, where substituent R is a linear or branched alkyl or aryl chain having from 4 to 10 carbon atoms.

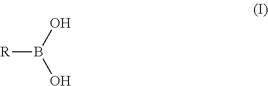

The reactivity and properties of boronic acids is highly dependent upon the type of carbon group “R” directly bonded to boron.

Structurally, boronic acids (RB(OH)₂) are trivalent boron-containing organic compounds that possess one alkyl or aryl substituent (i.e., a C—B bond) and two hydroxyl groups to fill the remaining valences on the boron atom. With only six valence electrons and a consequent deficiency of two electrons, the sp²-hybridized boron atom possesses a vacant p orbital. By virtue of their deficient valence, boronic acids possess a vacant p orbital. This characteristic confers them unique properties as mild organic Lewis acids that can coordinate basic molecules. By doing so, the resulting tetrahedral adducts acquire a carbon-like configuration. Thus, despite the presence of two hydroxyl groups, the acidic character of most boronic acids is that of a Lewis acid, rather than a Bronsted acid.

When coordinated with an anionic ligand, although the resulting negative charge is formally drawn on the boron atom, it is in fact spread out on the three heteroatoms. The ability to ionize water and form hydronium ions by indirect proton transfer characterizes the acidity of most boronic acids in water. Hence, the most acidic boronic acids possess the most electrophilic boron atom that can best form and stabilize a hydroxyboronate anion. Formula (II) depicts the ionization equilibrium of boronic acids in water.

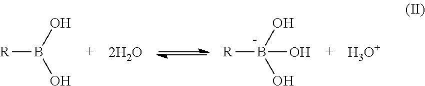

Hence, the most acidic boronic acids possess the most electrophilic boron atom that can best form and stabilize a hydroxyboronate anion.

2. Hydrophobic Tail Group

Any appropriate tail group having a backbone of from 4 to 10 carbon atoms long can be used herein, for example an alkane hydrocarbon group, a perfluoroalkyl group, and/or a polysiloxane group. The tail group is typically a C₄-C₁₀ hydrocarbon, such as a linear or branched alkyl or aryl radical. In one embodiment, the tail is a hydrocarbon derived from plant or petroleum-based oils. In particular embodiments, one or more of the tail carbons can be substituted with a non-carbon element. That is, the tail is an organo-compound material to which one or more non-oxygen hetero-atoms replace one or more carbon atoms in a hydrocarbon chain of an organic material and/or acts in the stead of a carbon atom in an otherwise hydrocarbon chain of an organic material. For example, some or all of the hydrocarbon tail group can be substituted by a silicone- or fluorocarbon-chain hydrophobic group. When non-carbon atoms are present in the stead of a carbon atom, these non-carbon atoms are counted as part of the carbon chain length.

### III. Mechanism of Action

The present invention provides concentrated alkali solutions having a dynamic surface tension profile similar to that of traditional industrial solvents. Because of its ultra-low surface tension, this “alkali solvent” wets, penetrates, and soaks into substrates much better than do traditional alkali solutions.

As commonly known to scientists, water is a very interesting material that does not always follow expected behavioral patterns as observed with other liquids. It exhibits peculiar behaviors such as increasing density when transforming from a solid to a liquid. Another interesting behavior involves the formation of water clusters of various sizes, under different circumstances. For example, for high alkali concentration solutions, water clusters of various configurations are formed. It is believed that the formation in the presence of water clusters affects the performance of different surfactants.

Concentrated alkali solutions have a significantly different structure and surface tension than do dilute aqueous solutions. Not wishing to be limited by theory, this innovation involves understanding the construct of high alkali solutions in the presence of water clusters, such as adducts of H₇O₄⁻(3H₂O.OH⁻) and H₉O₅⁻(4H₂O.OH⁻). Applicants surprisingly discovered that an effective surfactant for such a system will be different than for those useful in low concentration alkali aqueous systems.

At very high caustic solution concentrations, the water present in the solution does not behave as a traditional aqueous solvent, due to the water's predominant existence as water clusters. This produces a high water cluster solvent system with very little free water present.

When ionic compounds such as alkaline hydroxides or salts are added, primary water clusters form about the partially disassociated cationic and anionic members. Water molecules that form a primary water cluster about the anionic part form a water clusters that comprises a partial negative charge, a primary δ−water cluster. In a complementary process, a primary δ+water cluster forms where water molecules are in close proximity to the cationic member. The primary δ+water cluster comprises a partial positive charge. The δ− and the δ+ primary water cluster associate with one another as near neighbors due to the opposite partial charges.

The number of water molecules which comprise the primary water cluster depends upon the molar concentration of the ionic compound within the solution and the particular components of the ionic compound. It is also noted that these factors influence the number of nearby-attracted hydroxyl ions which associate with a primary water cluster.

For example, while not wishing to be bound by theory, it is hypothesized that for 1M KOH, the number of water molecules that comprises a primary δ−water cluster that associates with the OH-hydroxyl probabilistically comprises a plurality of four water molecules, possibly with an additional hydroxide or water molecule associated with it at a distance. Concurrently, the number of water molecules that comprise a primary δ+ water cluster that associates with the K+ cation species probabilistically comprises a plurality of seven water molecules, possibly with an additional one or two hydroxide or water molecules associated with it at a distance. Because there is an abundance of available water molecules, the secondary water cluster shells form around the primary water clusters. For the OH— and K+ species at 1M, their secondary shells involve a greater number of water molecules. Those molecules are not as tightly bound as the water molecules of the primary water cluster. This still leaves additional water molecules that at any given time are not in association with a water cluster, and thus are free to move about. Specifically for 1M KOH, numerous water molecules are available for this free movement state for every molecule of KOH. It is in this situation where traditional surfactants fail to decrease surface tension, and therefore cease to work.

As the molarity of the KOH solution increases, the number of water molecules decreases. At first, the water molecules will continue to migrate to the partially charged primary water clusters. These clusters are more tightly associated with the K+ and the OH— ions. If sufficient water molecules remain, at least partial secondary shells form. As KOH molarity increases, the number of free water molecules decreases to the point where there is not enough water available to create full secondary shells, and very little water, if any, is available to move freely. In this situation, traditional surfactant species cease to work, as they cease to decrease surface tension. Applicants realized that a different type of surfactant is needed to work in this environment, and developed the present invention as a solution to this problem.

To reduce surface tension in water cluster dominant solutions (such as created by high molarity ionic compound addition) one or both of electron deficient center or electron rich center molecules have been found useful. The former can be associated with the δ−water cluster to provide surface tension lowering, while the latter can be associated with the δ+water cluster to provide surface tension lowering.

Applicants discovered that in high concentration alkali solutions, effective surfactants have a Lewis acid head functionality and a shorter than conventional surfactant tail (e.g. C₄₋₁₀ versus the conventional C₁₂₋₁₈ surfactant tail). As demonstrated by the examples herein, these solutions have superior efficacy in a variety of areas where highly concentrated alkali is utilized.

Although not wishing to be limited by theory, it is believed that an inflection point is reached in the range of 4 to 5 M KOH, which is believed to signal a dramatic change in the water's structure. Other alkali solutions will also exhibit an inflection range, the range depending upon the particular alkali present. As used herein, the inflection point is the point at which the surface tension of the alkali surfactant composition is 40 mN (milliNewtons) below that of the starting alkali composition, at 51 ms. Surface tension is measured at 51 ms, as measurements at this time point strongly correlate with the composition's cleaning ability.

Applicants have found that an important character of effective dynamic surface tension reduction in water cluster dominant environments is a shorter tail length. For example, many traditional surfactants that are employed in non-water cluster dominate aqueous solutions have a carbon chain with a moderate to long number of carbons comprising a surfactant tail, such as C₁₂ or C₁₄ tails. In aqueous solutions with sufficient numbers of available free water molecules, the long hydrophobic tails can sufficiently position themselves among the water molecules such that the force of repulsion is not overly excessive and drives the surfactant out of solution or causes other undesirable effects. But in water cluster dominant solutions with little or no free water about, the surfactant tails must work to position themselves about the larger water clusters with partial charges. This is a higher repulsive force environment such that the traditional carbon tail lengths do not lead to a lowered surface tension. However it has been found that the surfactants of this invention which employ shorter chain lengths (therefore with less repulsive force) lead to reduced dynamic surface tension effects.

The ability of an aqueous solution to contact a solid or liquid, and the ability to spread over a surface, commonly referred to as the wetting ability, is an important property for alkaline solutions, especially for the cleaning of hard surfaces Improved contact can be facilitated by the reduction in surface tension of high concentration alkali solutions. It has been surprisingly discovered that the surface tension of highly concentrated alkali solutions can be reduced beyond what was conventionally thought possible through the use of surfactant agents having these very specific properties. This improves the contact of the alkali with the intended target solid or liquid solution, thereby boosting the alkali efficacy. Improved contact can be manifested in a variety of useful ways such as improved contact, penetration, spreading, permeation, or diffusion into or within a solid or liquid.

### III. Composition Forms and Uses

The present invention provides methods for treating a substrate. In one aspect, the method comprises the step of contacting the substrate with a composition comprising, or in some cases consisting essentially of, an aqueous alkali surfactant composition having a hydroxide molarity of from 2 to 9, and comprising: (a) alkali; and (b) a surfactant having a boronic acid or boronic acid derivative Lewis acid head group positioned terminally in a linear or branched aliphatic or aryl hydrocarbon chain comprising from 4 to 10 carbon atoms.

As used herein, “treating” means affecting the substrate to result in a desired change or transformation. The composition can be used in any suitable process where concentrated alkali solutions are typically used. Use of the composition results in a more effective process with greater surface tension reduction between the alkali solution and surfaces contacted. In one aspect, the invention provides a method for treating a substrate comprising contacting the substrate with an effective amount of the inventive composition described.

The composition can contact the substrate by any suitable means, such as lavage (e.g., washing with repeated injections of solution), misting, spraying, diluting, mopping, pouring, dipping, soaking, and combinations thereof. Where appropriate, contacting can be followed by removing the alkali surfactant composition through any suitable means, including flushing, rinsing, draining, lavage, misting, spraying, mopping, wiping, rinsing, dipping, and combinations thereof, for example with a clean liquid such as water.

The substrate to be treated can be made from any suitable material, including but not limited to metal, stainless steel, plastic, ceramic, porcelain, rubber, wood, concrete, cement, rock, marble, gypsum, and glass. Typical examples of substrates include surfaces in need of cleaning or modification, as well as components used in manufacturing a good. As used herein, “component” means a part, portion, or ingredient of a good that is contacted with the alkali surfactant in the process of manufacturing the good. For example, a metal manufacturing process utilizing alkali surfactant in one or more steps would comprise at least one metal component, since the alkali surfactant contacts materials used in the making process, rather than contacting the finished metal itself.

The concentration and amount of alkali surfactant that is needed to effectively treat a given substrate will depend upon factors such as the specific alkali surfactant used, the type of substrate treated, and the level of treatment desired, all of which can be determined by one skilled in the art in view of this disclosure. Thus, it can be said that the amount of alkali surfactant needed for any substrate will be an “effective amount”. As used herein, an “effective amount” is the amount (i.e., concentration, quantity) of alkali surfactant solution needed to achieve the desired level of treatment for a particular application.

The composition can be in any suitable form. For example, product forms can include those such as liquids, gels, pastes, and suspensions, as well as concentrates. Products or concentrates of such can be contained and deployed (e.g., dispensed and deposited upon a substrate) with a variety of containers, vessels, tanks, or packages ranging from small (e.g. for household use) to large dose volumes (e.g., for industrial cleaning), wherein said containers can be re-usable (e.g., plant tanks) to disposable (e.g., a small bottle or pouch). The container can contain enough product for a single use event or for multiple uses. The composition can be a fully-formulated ready-for-use product, or can require preparation before use. For example, the composition can be in the form of a kit comprising composition ingredients and instructions for preparation, or can be a concentrate for dilution either within or outside the container.

The compositions can optionally include any suitable adjunct ingredients, such as those known in the art for use in such compositions. For example, sodium hydroxide based detergents often include rust inhibitors and defoamers.

The compositions can be useful in a wide range of environments (e.g., industrial, commercial, office, home and vehicle) for a variety of applications (e.g., cleaning, manufacturing, and products formulation). Typical uses include, but are not limited to, heavy duty and industrial cleaning, chemical pulping, mercerization, metal processing (e.g., production, metal etching and modification), leather processing, food processing, and personal care product manufacture and methods/applications utilizing such personal care products. Some of these uses are discussed further below.

Cleaning: The composition provides improved solubility, wetting, and cleaning ability, and can dissolve grease, oils, fats and protein-based depositions, making it particularly suitable for improved cleaning processes, including removal of tough soil and bio-films. Cleaners may broadly take the form of removers, strippers, degreasers, sanitizers, detergents, soaps, cleaning agent, or any other appropriate form as desired. Substrates suitable for cleaning with the alkali surfactant composition can include those found in a variety of systems, such as those of the industrial, marine, automobile, and household environments.

Industrial systems can include those such as cooling water systems, heat exchangers, pulp and paper manufacturing, food processing systems, metalworking, photo processing, reverse osmosis membranes, water processing, flow channels, turbines, solar panels, pressurized water reactors, injection and spray nozzles, steam generators, process equipment, secondary oil recovery injection wells, and piping (e.g., drinking water). The composition can also be used as a grease & oil cleaner for engines and machinery, remover of inks and varnishes from print plates/cylinders, and as a parts degreaser. Marine systems can include pipelines (e.g., of the offshore oil and gas industry), off-shore oil rigs, and ship hulls. Household systems include those surfaces found in swimming pools, toilets, household drains, and other household surfaces such as cutting surfaces, sinks, counter-tops, shower and bath surfaces, vases, pet food/water bowls, decorative water landscaping (e.g., fountains, ponds), and bird baths. The composition can also be utilized as an oven cleaner, grill cleaner (e.g., grill surface, apparatus, utensils), degreaser on stainless steel and glass bakeware, varnish and paint stripper, road tar remover, deck cleaner; furniture cleaner, wheel cover cleaner; airplane, boat, truck, automobile or motorcycle surface cleaner; window cleaner; personal care compositions; nail polish remover; adhesive tape remover, and glue remover.

Chemical Pulping: Sodium hydroxide is widely used in pulping of wood for making paper or regenerated fibers. Along with sodium sulfide, NaOH is a key component of the white liquor solution used to separate lignin from cellulose fibers in the Kraft process. It also plays a key role in several later stages of the process of bleaching the brown pulp resulting from the pulping process. These stages include oxygen delignification, oxidative extraction, and simple extraction, all of which require a strong alkaline environment with a pH>10.5 at the end of the stages.

Mercerization: Mercerization is a process by which cotton (or other cellulose fiber) is treated with a high concentration of Sodium Hydroxide (or other metal hydroxides) to improve dye affinity, chemical reactivity, dimensional stability, tensile strength, luster, and/or smoothness. The alkalis penetrate the cotton fiber and convert the cellulose crystal structure from cellulose 1 to cellulose 2.

Bayer Process for Metal Production: In the Bayer process, sodium hydroxide is used in the refining of alumina containing ores (bauxite) to produce alumina (aluminium oxide) which is the raw material used to produce aluminum metal via the electrolytic Hall-Héroult process. Since the alumina is amphoteric, it dissolves in the sodium hydroxide, leaving impurities less soluble at high pH such as iron oxides behind in the form of a highly alkaline red mud. Other amphoteric metals are zinc and lead which dissolve in concentrated sodium hydroxide solutions to give sodium zincate and sodium plumbate respectively.

Aluminum (metal) surface etching and modification: Strong bases attack aluminum. Sodium hydroxide reacts with aluminium and water to release hydrogen gas. The aluminium takes the oxygen atom from sodium hydroxide (NaOH), which in turn takes the oxygen atom from the water, and releases the two hydrogen atoms. The reaction thus produces hydrogen gas and sodium aluminate. In this reaction, sodium hydroxide acts as an agent to make the solution alkaline, which aluminium can dissolve in. This reaction can be useful in etching, removing anodizing, or converting a polished surface to a satin-like finish, but without further passivation such as anodizing or alodining the surface may become degraded, either under normal use or in severe atmospheric conditions.

Leather Processing: Because aggressive bases like KOH damage the cuticle of the hair shaft, potassium hydroxide is used to chemically assist the removal of hair from animal hides. The hides are soaked for several hours in a solution of KOH and water to prepare them for the unhairing stage of the tanning process.

Food preparation, including large scale processes: Food uses of sodium hydroxide include washing or chemical peeling of fruits and vegetables, chocolate and cocoa processing, caramel coloring production, poultry scalding, soft drink processing, and thickening ice cream. Olives are often soaked in sodium hydroxide for softening. Food uses can also include the preparation of lutefisk, hominy, hominy grits, and pretzels.

Drain Cleaner: The alkali dissolves greases to produce water soluble products. It also hydrolyzes the proteins such as those found in hair which may block water pipes.

Personal Beauty Care: Potassium hydroxide is often the main active ingredient in chemical “cuticle removers” used in manicure treatments. Pre-shave products and some shave creams contain potassium hydroxide to force open the hair cuticle and to act as a hygroscopic agent to attract and force water into the hair shaft, causing further damage to the hair. In this weakened state, the hair is more easily cut by a razor blade. Other uses include in chemical relaxers to straighten hair, depilatories, and permanent-wave products for hair curling.

### Analytical Methods

### Dynamic Surface Tension

The dynamic surface tension of a liquid may be determined by using a tensiometer. The tensiometer may measure the dynamic surface tension of the liquid according to the bubble pressure method. The bubble pressure method includes injecting a gas, such as air, into a liquid that is to be analyzed. The gas enters the liquid through a capillary that is immersed within the liquid. The difference in pressure between the gas and the liquid is recorded at several gas flow rates. The difference in pressure for each flow rate that is required to form a bubble is proportional to the surface tension of the liquid by the Young-Laplace equation, as reproduced below:

$$σ = \frac{Δ p \cdot d}{4}$$

where Δp is the pressure differential between the pressure inside the gas bubble and the pressure outside the gas bubble within the liquid in Newtons per square meter (N/m²); d is the diameter of the capillary in meters (m); and σ is the surface tension of the liquid in Newtons per meter (N/m). The dynamic surface tension of the liquid is calculated for each gas flow rate using the Young-Laplace equation for each flow rate. The bubble lifetime is equal to the time elapsed between the formation of the each bubble and is recorded for each flow rate. The calculated dynamic surface tension values are plotted versus the bubble lifetime.

The method of measuring the dynamic surface tension of a liquid may generally include the steps of: (1) calibrating the tensiometer; (2) cleaning the capillary of the tensiometer; and (3) measuring the dynamic surface tension and bubble lifetime of the liquid with the tensiometer. The method of measuring the dynamic surface tension of a liquid with a tensiometer may, for example, generally follow American Society for Testing and Materials standard ASTM D3825-09.

A SITA science line t60 tensiometer, available from SITA Messetechnik GmbH (Dresden, Germany), may be used to measure the dynamic surface tension of a liquid, such as an electrolyte solution. The t60 tensiometer may be calibrated according to SITA Messetechnik instructions with the tensiometer in Calibration Mode. See SITA science line t60 Manual, p. 4, Section 12.1. The calibration is completed by placing the tip of the capillary tube of the tensiometer into about 25 mL of deionized (DI) water that is held within a glass vessel, such as a 50 mL beaker. The tip of the capillary tube should extend into the solution to the manufacturer's recommended depth that is signaled by a mark on the temperature probe of the tensiometer. The temperature of the DI water should be between about 20° C. and about 30° C.

The t60 tensiometer may then be cleaned according to SITA Messetechnik instructions with the tensiometer in Cleaning Mode. See Id., p. 20, Section 12.4. The capillary tube may first be rinsed with DI water. The cleaning is completed by placing the tip of the capillary tube of the tensiometer into about 25 mL of deionized (DI) water that is held within a glass vessel, such as a 50 mL beaker. The tip of the capillary tube should extend into the solution to the manufacturer's recommended depth that is signaled by a mark on the temperature probe of the tensiometer. The temperature of the DI water should be between about 20° C. and about 30° C. Air is rapidly bubbled through the capillary tube of the tensiometer for about two (2) minutes.

The t60 tensiometer may then be used to obtain dynamic surface tension of the liquid solution to be analyzed. The data may be obtained according to SITA Messetechnik instructions with the tensiometer in Auto-Measurement Mode. See Id., p. 18, Section 12.3. The auto-measurement is completed by placing the tip of the capillary tube of the tensiometer into about 25 mL of the liquid solution that is held within a glass vessel, such as a 50 mL beaker. The tip of the capillary tube should extend into the solution to the manufacturer's recommended depth that is signaled by a mark on the temperature probe of the tensiometer. The temperature of the solution being analyzed should be between about 20° C. and about 30° C. The Auto-Measurement may cover a bubble lifetime range from about thirty milliseconds (“ms”) to about ten seconds (“s”). The dynamic surface tension of the liquid solution being analyzed over the range of bubble lifetimes may then be recorded. For purposes of the present invention, the dynamic surface tension is measured at a temperature of about 25° C. at a bubble lifetime of 51 ms.

Unless otherwise indicated, either expressly or by context, the term “surface tension” as used herein refers to dynamic surface tension.

### EXAMPLES

### Example 1

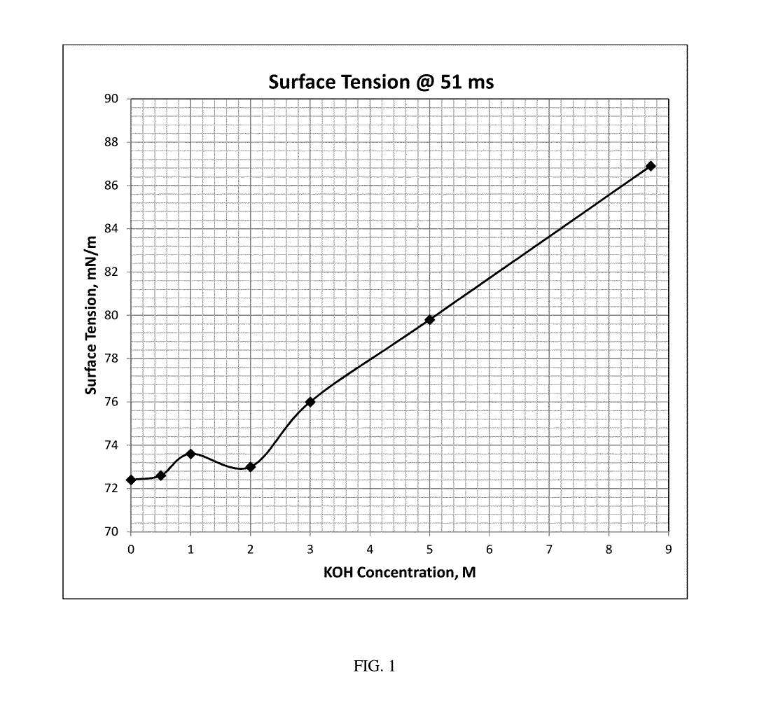

Aqueous solutions of KOH were prepared at various molarities (M) as shown in Table 1. The dynamic surface tension (at 51 ms) of each solution was measured according to the analytical method set forth herein. KOH concentration versus measured surface tension was plotted (FIG. 1), demonstrating that the surface tension of aqueous alkali solutions tends to increase with increasing alkali concentration.

TABLE 1
KOH Surface Tension @ 51 ms

| | Surface Tension |
|---|---|
| KOH (M) | (mN/m) |
| 0 | 72.4 |
| 0.5 | 72.6 |
| 1.0 | 73.6 |
| 2.0 | 73 |
| 3.0 | 76 |
| 5.0 | 79.8 |
| 8.7 | 86.9 |

### Example 2

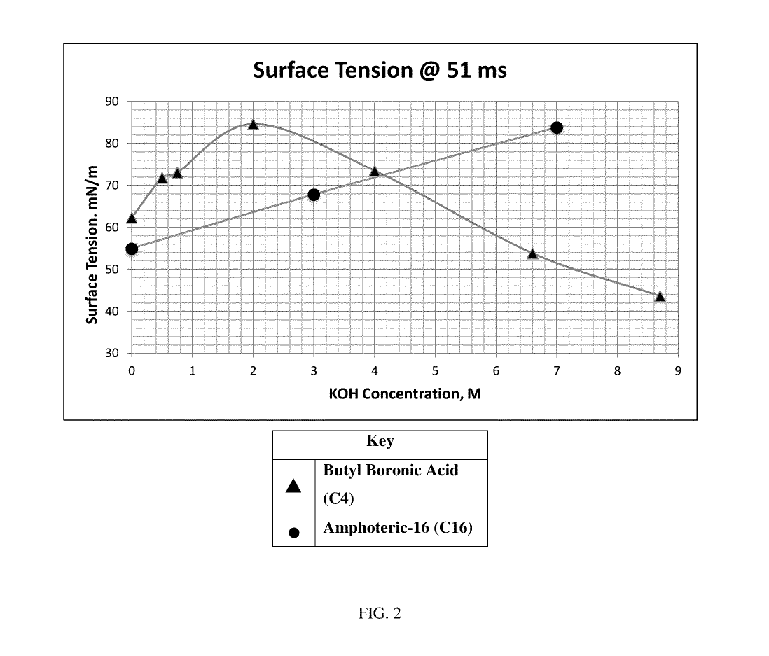

Aqueous alkali surfactant compositions containing various concentrations of KOH and one of either 1.5% Butyl Boronic Acid (C₄) or 1.5% Amphoteric-16 surfactant (C₁₆), were prepared as shown in Tables 2 and 3 below. The dynamic surface tension (at 51 ms) of each solution was measured according to the analytical method set forth herein. KOH concentration versus surface tension was plotted as in FIG. 2.

TABLE 2
Butyl Boronic Acid
(C₄)

| [KOH] | SFT, mN/m |
|---|---|
| 0 | 62.3 |
| 0.5 | 71.8 |
| 0.75 | 73 |
| 2 | 84.6 |
| 4 | 73.5 |
| 6.6 | 53.8 |
| 8.7 | 43.6 |

TABLE 3
Amphoteric-16 (C₁₆)

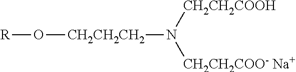

| [KOH] | SFT, mN/m |
|---|---|
| 0 | 54.9 |
| 3 | 67.8 |
| 7 | 83.8 |

### Example 3

### Alkali Surfactant Cleaning Composition Preparation

Four separate concentrations of KOH were prepared; 1 M, 3 M, 5 M & 8.7 M from 45% KOH_{(aq)} (11.63 M) stock solution. 1 M KOH (3.86%): A 100 mL volumetric flask was charged with 15 mL of deionized water followed by slowly adding 8.60 mL of stock 45% KOH. To this homogeneous solution was added 0.33 grams (3.24 mmol) butyl boronic acid. The resultant solution was diluted to 100 mL.

### Example 4

Alkali surfactant solution in three different KOH concentration was prepared as shown in table 4 in a 500 mL volumetric flask from a stock solution of 8.9 M KOH.

TABLE 4

| | | KOH, | 8.9M KOH | n- | | Total |
|---|---|---|---|---|---|---|
| | KOH, | % | Volume, | Hexylboronic | | volume, |
| | M | w/v | mL | Acid, g | Water | mL |
| 1 | 5.35 | 30.00 | 300 | 2.5 | qs | 500 |
| 2 | 6.00 | 33.66 | 336.6 | 2.5 | qs | 500 |
| 3 | 6.60 | 37.00 | 370 | 2.5 | qs | 500 |

Soiled stainless steel grill grates in which the soil is mostly composed of oxidized and polymerized grease and fats mixed with charred protein and carbohydrate residues were exposed to the alkali surfactant solution by means of brushing. spraying or alternatively immersing the grates in alkali solution bath and after a few minutes of contact time, gently scrubbed and rinsed clean with water.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aqueous alkali-surfactant solution having a hydroxide molarity of from 2 to 9 M that comprises:
(a) alkali; and
(b) a surfactant having a boron-centered head group positioned terminally in a linear or branched aliphatic or aryl hydrocarbon chain comprising from 4 to 10 carbon atoms.

2. The solution of claim 1, wherein said boron-centered head group is selected from the group consisting of boronic acids, boroxines, boronic esters, boranes, and combinations thereof.

3. The solution of claim 1, wherein said surfactant is selected from the group consisting of butyl boronic acid; pentyl boronic acid; hexyl boronic acid; isobutyl boronic acid; phenyl boronic acid; 3,5-Dichlorophenyl boronic acid; 3,5-bis(Trifluoromethyl)phenyl boronic acid; 3-Methoxyphenyl boronic acid; 4-Methoxyphenyl boronic acid; 4-Carboxyphenyl boronic acid; 2-Nitrophenyl boronic acid; 4-Nitrophenyl boronic acid; 4-Bromophenyl boronic acid; 4-Flourophenyl boronic acid; 2-Methylphenyl boronic acid; 3-Methylphenyl boronic acid; 4-Methylphenyl boronic acid; 3,5-Dimethylphenyl boronic acid; derivatives thereof, and combinations thereof.

4. A treatment process comprising the step of contacting a substrate with an effective amount of the aqueous alkali-surfactant solution of claim 1.

5. The treatment process of claim 4, wherein said treatment process is selected from the group consisting of cleaning, chemical pulping, mercerization, metal processing, leather processing, food processing, and personal beauty care.

6. The treatment process of claim 4, wherein said treatment process is cleaning and said substrate is selected from the group consisting of cooling water systems, heat exchangers, photo processing components, reverse osmosis membranes, flow channels, turbines, solar panels, pressurized water reactors, injection and spray nozzles, steam generators, oil recovery injection wells, piping, engines, machinery, inks and varnishes present on print plates/cylinders, auto parts, machinery parts, pipelines, off-shore oil rigs, ship hulls, swimming pools, toilets, household drains, household food preparation surfaces, sinks, counter-tops, shower and bath surfaces, vases, pet food/water bowls, decorative water landscaping, bird baths, ovens, grills, grill utensils, stainless steel, glass bakeware, surfaces covered with varnish or paint, road tar, decks, furniture, wheel covers, airplanes, boats, trucks, automobiles, motorcycles, windows, surfaces covered with nail polish, surfaces covered by tape adhesive, and surfaces covered with glue.

7. The treatment process of claim 4, wherein said treatment process is chemical pulping and said substrate is selected from the group consisting of wood, cellulosic fibers, and pulp.

8. The treatment process of claim 4, wherein said treatment process is mercerization and said substrate is cotton.

9. The treatment process of claim 4, wherein said treatment process is a metal processing process selected from the group consisting of metal manufacture, surface etching, and surface modification, and wherein said substrate is metal.

10. The treatment process of claim 4, wherein said treatment process is leather processing and the substrate is animal hide.

11. The treatment process of claim 4, wherein said treatment process is food processing and the substrate is selected from the group consisting of fruits, vegetables, chocolate components, cocoa components, caramel components, poultry, soft drink components, ice cream components, olives, lutefisk components, corn, and pretzel components.

12. The treatment process of claim 4, wherein said treatment process is personal beauty care and said substrate is selected from the group consisting of cuticles and hair.

13. The treatment process of claim 4, wherein said substrate is selected from the group of materials consisting of metal, stainless steel, plastic, ceramic, porcelain, rubber, wood, concrete, cement, rock, marble, gypsum, and glass.

14. The treatment process of claim 4, wherein said boron-centered head group is selected from the group consisting of boronic acids, boroxines, boronic esters, boranes, and combinations thereof.

15. The treatment process of claim 4, wherein said surfactant is selected from the group consisting of butyl boronic acid; pentyl boronic acid; hexyl boronic acid; isobutyl boronic acid; phenyl boronic acid; 3,5-Dichlorophenyl boronic acid; 3,5-bis(Trifluoromethyl)phenyl boronic acid; 3-Methoxyphenyl boronic acid; 4-Methoxyphenyl boronic acid; 4-Carboxyphenyl boronic acid; 2-Nitrophenyl boronic acid; 4-Nitrophenyl boronic acid; 4-Bromophenyl boronic acid; 4-Flourophenyl boronic acid; 2-Methylphenyl boronic acid; 3-Methylphenyl boronic acid; 4-Methylphenyl boronic acid; 3,5-Dimethylphenyl boronic acid; derivatives thereof, and combinations thereof.

16. The treatment process of claim 4, wherein said alkali is alkali metal salt.

17. The treatment process of claim 16, wherein said alkali metal salt is selected from the group consisting of Potassium hydroxide (KOH), Barium hydroxide (Ba(OH)₂), Cesium hydroxide (CsOH), Sodium hydroxide (NaOH), Strontium hydroxide (Sr(OH)₂), Calcium hydroxide (Ca(OH)₂), Lithium hydroxide (LiOH), Rubidium hydroxide (RbOH), and combinations thereof.

18. The treatment process of claim 4, wherein said alkali is non-metal base.

19. The treatment process of claim 18, wherein said non-metal base comprises ammonium hydroxide or alkyl substituted ammonium hydroxide

20. The treatment process of claim 19 wherein said alkyl substituted ammonium hydroxide is selected from the group consisting of tetramethyl ammonium hydroxide, trimethyl ammonium hydroxide, tributylammonium hydroxide, tetrabutyl ammonium hydroxide, and combinations thereof.
